(19) United States
(12) Patent Application Publication
(10) Pub. No.: US 2012/0248852 A1
(43) Pub. Date: Oct. 4, 2012

(54) Wheel lug ring

(76) Inventor: Craig McClain Matsler, Creswell, OR (US)

(21) Appl. No.: 13/065,712

(22) Filed: Mar. 29, 2011

(51) Int. Cl. B60B 7/01; B23P 11/00

(52) U.S. Cl. 301/37.24; 29/428

(57) ABSTRACT

A lug nut covering device, called a lug ring, for a wheel comprising a circular ring with a convex exterior side, a concave interior side, reinforcement webbing attached to an inner wall of the concave interior side, one or more lug wells strategically placed within the reinforcement webbing wherein the lug wells fit over and onto one or more lug nuts on a wheel. The lug ring is a device to cover the lug nuts and wheel studs for decorative and protective purposes. The convex exterior can be made from any hard material including, aluminum alloys depending on the look that is desired. In the preferred embodiment, the interior portion of the lug ring is made from a high impact plastic, like a polycarbonate (PC). When the lug ring is pressed onto the lug nut, the walls of the lug well compresses upon the hard metal of the lug nuts and firmly attaches the lug ring to the wheel.

### CROSS REFERENCE TO RELATED APPLICATION

None

### BACKGROUND OF THE INVENTION

This invention relates generally to a covering device for a vehicle's wheel and more specifically to a cover for lug nuts and wheel studs on a vehicle's wheels. Similar devices can be deployed on any vehicle that uses a wheel stud and lug nut to secure the wheel and tire to a vehicle as long as the lug nuts and wheel studs are exposed for attaching the covering device. A lug nut is a fastener, specifically a nut, used to secure a wheel on a vehicle. Typically, lug nuts are found on automobiles, trucks, and other large vehicles utilizing rubber tires. Stud and nuts are used to secure wheels and tires to a vehicle allowing easy removal for replacement or repair of a tire due to wear and tear.

A typical lug nut can be described as being a nut with a threaded interior and a hexagonal shaped exterior and sometime with a rounded or conical (tapered) end exterior, the latter being used for esthetic reasons. Lug nuts are used on steel and most aluminum style wheels. One or more lug nuts are used to secure a wheel to a threaded wheel stud to a vehicle's axles. Generally, wheel studs are semi-permanently mounted directly to the vehicle brake drum or disc hub in a circular pattern. The studs extend axially away from the drum or hub. A wheel and tire are placed over the studs with the lug nut securing the wheel and tire to the vehicle. Besides securing the wheel to the vehicle, many lug nuts have been designed and manufactured to provide a pleasant view of the tire. Wheel coverings can come in many types of alloys and finishes, but the preferred finish is a chrome or polished steel façade.

Due to the number, detail, and type of finish on lug nuts, there are increasingly more products and devices dedicated for the cleaning and polishing of the lug nut and wheel area. There are many chemical cleaners on the market to remove road grime, dust and oils. The chemical cleaners usually tout their ability to remove the various types of road dirt while ensuring the wheel covering and lug nut are not chemically corroded, pitted or damaged by use of the chemical cleaners. Additionally, there are many types of devices that are used for cleaning the area around the stud and lug nut, including: U.S. Pat. No. D458425, Wheel and Lug Nut Cleaning Tool, issued to Large (June 2002) disclosing an ornamental design for a wheel and lug nut cleaning tool. Utility patents have been issued for the same purpose, including; U.S. Pat. No. 6,754,932, Lug nut and hub cap and rim receptacle cleaning device, issued to Buzard (issued June 2004), disclosing a tool or device used for cleaning vehicular lug nuts or lug nut covers and the surfaces of lug nut or lug nut cover receiving receptacles of hub caps or rims. In addition to patented items for this purpose, there are many commercial items on the market that accomplish the task of cleaning wheel studs and lug nuts.

The number and type of decorative wheel coverings has increased as well with truck operators wanting to improve the appearance of their trucks and trailers. The market for the various types of decorative wheel covers has increased greatly over the last twenty years. Several of the patented items for wheel covers include, U.S. Pat. No. 5,286,092 issued to Maxwell (issue date February 2004) which discloses a decorative wheel cover for the wheel of a truck. U.S. Pat. No. 5,842,749 issued to DiMarco (issue date December 1998) which discloses a covered lug retention assembly for a wheel cover. U.S. Pat. No. 6,135,570 issued to Wieczorek (issue date October 2000) which discloses a wheel cover having a one-way locking mechanism and decorative nut cap. There are many other patents, both utility and design patents, which disclose decorative, wheel covers.

Another aspect of the wheel covers is the utility in protecting the lug nut and wheel stud from road dirt and grime. Many of the decorative wheel cover patents include the utility of preventing road dirt and grime from contacting the threads and contact point of the lug nut and wheel studs. Grime, dirt, moisture and other road material that is able to contact and penetrate the nooks and crannies of the lug nut and wheel stud can cause corrosion and weakening of the securing capability of the lug nut. U.S. Pat. No. 6,273,658 issued to Patterson et al. discloses a device that covers the lug nut and wheel stud in a casing that has grease or some similar type water resistant material within.

There is need for a decorative wheel cover that provides some protection for the wheel stud and lug nuts from corrosion, road dirt, grime and moisture that is easy to clean and provides the user with a pleasant appearance. Therefore, it would be desirous to have a lug nut cover that could be easily installed and removed and that protects and covers the wheel studs and lug nuts while providing a pleasant visual appearance. Additionally, the covering should be easily put on and taken off to allow the user to replace worn or flattened tires. The covering should be able to stay on a vehicle tire under normal and extreme conditions a typical tire could experience. Lug nut covers mentioned in the prior art fall short of one or two of the ideal cover while this invention provides a cover that will be readily and easily cleaned, easy to put on and take off, and provides for the protection of the lug nut and wheel stud from corrosion, dirt and grime.

### BRIEF SUMMARY OF THE INVENTION

The improved lug nut cover or lug ring is a circular donut shaped piece that is used on the exterior of the wheel and tire assembly of vehicles that have exposed wheel studs and lug nuts. The lug ring is place directly over the wheel studs and lug nuts with the lug ring having a plurality of lug wells on the back side that fit over and onto the wheel studs and lug nuts. The lug wells are manufactured and sized such that the lug wells compress onto one or more of the lug nuts. The lug ring is able to be compressed onto the lug nut by using high impact plastics like a Polycarbonate (PC) or similar type material for the sides of the lug well and sizing the lug wells such that the PC of the inner wall of the lug well touches and then presses onto the sides of the lug nut, which are typically made of hard steel or similar alloy, when the lug ring is pressed onto the lug nut and wheel. The lug wells are dimensioned such that the lug nut is constricted in the lug well. The tight fit requires the use of a pry type device to remove the lug nut cover from the wheel when the lug ring is to be removed. The exterior of the lug nut cover is typically convex or rounded and sized to provide a sleek and aero-dynamic appearance to the wheel. The exterior of the lug nut cover can be polished metal or alloy, like chrome, or a colored hard plastic that reflects that color onto the surfaces of highly polished metal finishes used on most wheels.

While the preferred embodiment of the lug ring deploys a hard high density plastic on the interior side of the lug ring, the exterior can be made from either a hard plastic, hard metal, or a type of alloy from which the wheel is made—aluminum or similar metal. The lug ring can be made from other materials that allow the lug well to compress or fit snugly onto the lug nut. Materials that are not compressible can still be used with the addition of means for attaching the lug ring to the lug nut, such as clips or magnets.

This invention can be used on any type of open lug wheel. The invention is preferably used on commercial vehicles, like trucks that have hub piloted wheels or lug piloted wheels.

### BRIEF DESCRIPTION OF SEVERAL VIEWS OF THE DRAWINGS

FIG. 1 is a bottom view of the lug ring this is the concave side with five lug wells arranged around the lug ring.

FIG. 2 is a cross sectional view of the lug ring.

FIG. 3 a perspective top of the top side of the lug ring.

FIG. 4 is a perspective bottom view of the lug ring.

### DETAILED DESCRIPTION OF THE INVENTION

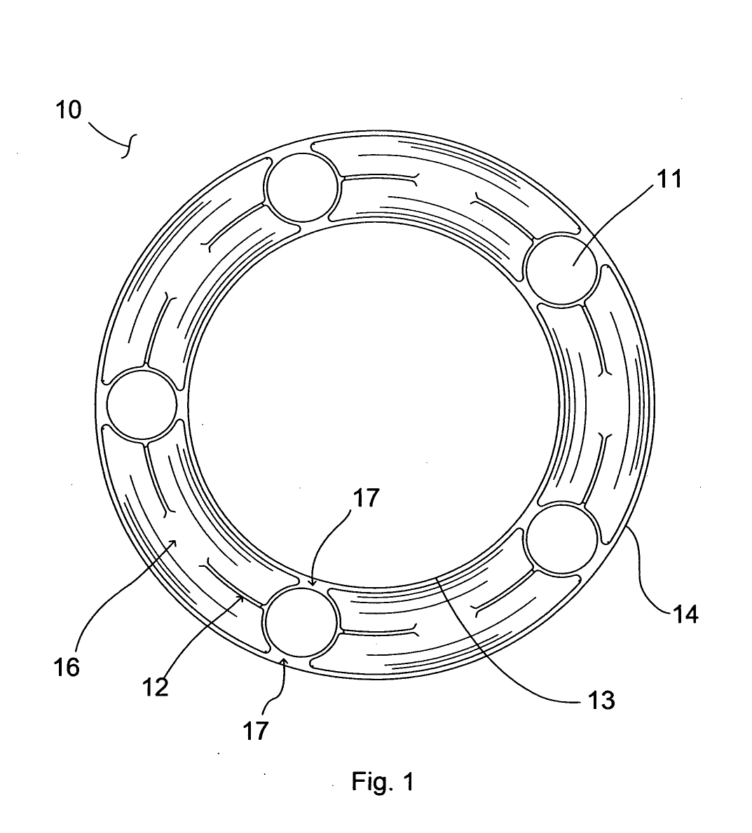

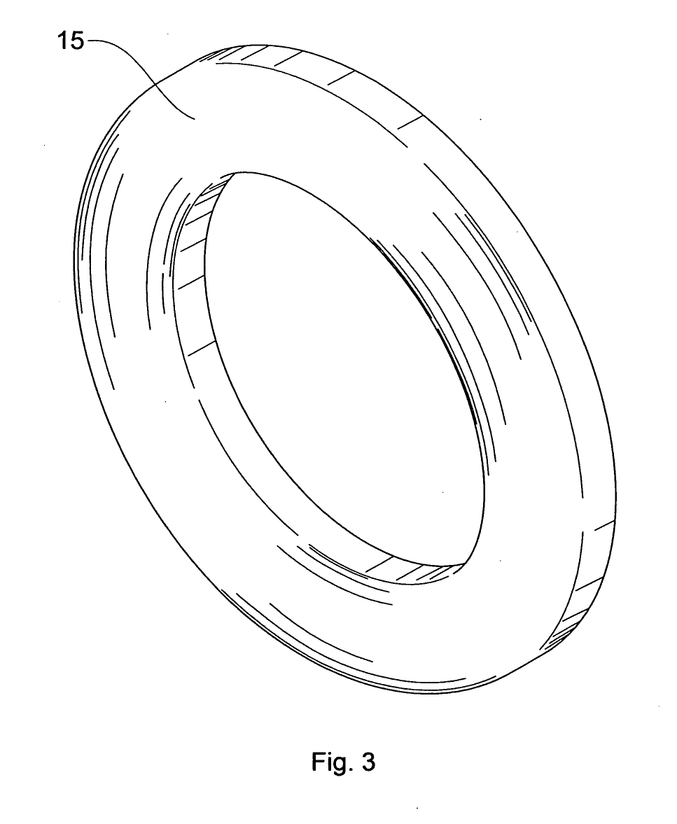

Referring to FIGS. 1 and 3, the lug ring 10 is a circular ring with a convex exterior side 15 which is typically curved or rounded and is exposed when placed on a vehicle's wheel. The interior side 16, faces toward the wheel when attached and is indented or concave between the interior outer diameter 14 and interior inner diameter 13 edges. One or more lug wells 11 are around the concave side of the lug ring. The lug wells are a built up structure in which the lug nut and studs are inserted to secure the lug ring to the wheel. The lug well sits or project from the well of the concave side of the lug ring and project no farther than the exterior and interior wall, providing for a flush or flat plane on the concave side of the lug ring. A reinforcement webbing 12 projects axially out of the concave portion of the lug ring and provide some stability to the lug wells. The lug wells stability is enhanced by attaching the lug wells directly to an inner wall by support arms 17 of the concave interior side of the lug ring 10. The lug wells are generally a hollowed out hole and dimensioned and sized for placing onto and over a lug nut and stud of a wheel.

The lug wells 11 are placed around the circular reinforcement webbing 12 such that the wells will align with one or more of the lug nuts which project from the wheel. The number, shapes and sizes of the lug wells will depend on the type of wheel, studs and lug nut the lug ring is to be used on. Typically, the shape of the lug well will correspond with the exterior surface of the lug nut—which is generally hexagonal. The interior side of the lug ring will attach or be placed upon the exterior side of the wheel where the wheel studs and lug nuts are exposed.

Typically, a hub is situated within the middle of the vehicle's wheel and protrudes out and away from the wheel. The lug nuts and wheel studs are generally evenly displaced around the hub in a circular design. In the center of the lug ring, the interior inner diameter edge 13 is sized to fit over and around the hub and is dimensioned accordingly depending on the size of the wheel and hub.

To place the lug ring onto the lug nuts, the user aligns the lug ring 10 such that the lug wells 11 line up or align to the lug nuts on the wheel, when the lug ring is aligned such that the lug nuts are in line with the lug wells 11, the lug ring is pressed onto the lug nuts of the wheel by the user. The lug well is sized to fit over the standard commercial lug nuts and the user will need to ensure that the lug well is sized to accept the lug nut in such a manner that the lug ring is not loose when the lug nut is engaged within the lug well.

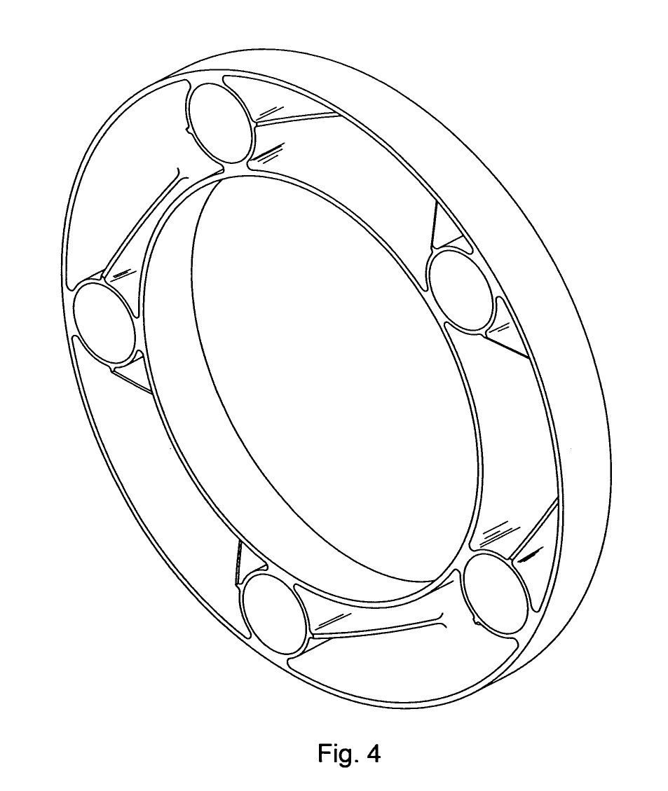

Refer to FIG. 4, the lug well's interior is dimensioned or sized to accept a standard hexagonal shaped lug nut with the size of the interior dimensions made to ensure a tight fit at the points of the hexagonal shaped nut when the lug nut is introduced to the lug well. When the lug well is pressed onto the hard metal hexagonal shaped lug nut, the points of the hexagonal nut press or deflect into the hard plastic or similar material used for the lug well making for a tight fit. In the preferred embodiment, the tight fit of the lug ring onto the lug nuts is similar to a compression fitting in that the compression into the lug well wall prevents the lug ring from coming off the lug nut until the lug ring is pried off the lug nut using a pry type device that applies force perpendicular to the compression force of the lug wall.

In the preferred embodiment of the invention, the sizing and depth of the lug well 11 will allow the user to compress the lug ring such that the compression of the lug well onto and around the lug nut occurs when the interior inner 13 and interior outer 14 diameter edges of the lug ring forms a near seamless joint with the wall of the tire's wheel. The joint will be tight and will provide some protection from exposure to natural elements penetrating to the lug wells and lug nuts. Additionally, the near seamless joints and the rounded or curved surface of the exterior of the lug ring allows for easier cleaning of the wheel area.

In the preferred embodiment, the reinforcement webbing 12 and the material from which the lug wells 11 are made from a polycarbonate (PC) material, which provides the benefits of impact toughness, dimensional stability, and heat and chemical resistance. PC is the preferred material for manufacturing the lug ring interior due to the physical qualities of this type of plastic. PC is resistant to many solvents, and the intrinsic tensile strength of PC make for a harder more durable device. When the lug ring is pressed onto the lug nut, the PC conforms or fits onto the hard metal surfaces of the exterior lug nut. This fit will ensure the lug ring stays on the wheel and does not come off during normal use of the vehicle. The lug ring can be removed and replaced repeatedly without reducing the ability of the lug well to form a compression like fit with the lug nut. This characteristic, of repeatedly being taken off and put back on without losing the compression fit, of the lug ring is due to the nature of the material that is used for the lug well, a hard dense plastic like material.

Another advantage of using the PC material and obtaining a compression type fit on the lug nut is to provide some protection from the natural elements and thereby minimizing the threaded wheel stud and lug nut from rust and corrosion. By minimizing the exposure of the threads from being exposed to dirt, grime, moisture and corrosive substances will ensure that the lug nuts are able to perform their primary function of fastening the tire and wheel onto the truck, trailer or vehicle.

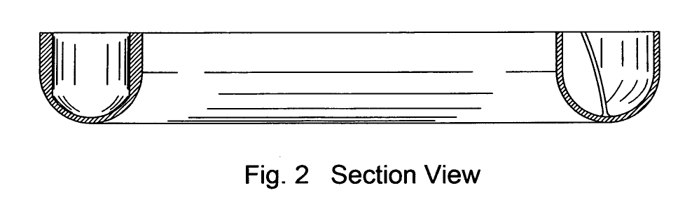

In the preferred embodiment, the number of lug wells 11 used for attaching to the lug nuts is three or more. Fewer than three lug wells used to fasten to the lug nuts may not ensure a tight or snug fit upon the lug nuts. The user can manually check the tightness of the fit by trying to rotate or pull the device off by hand once the lug ring has been pressed onto the lug nuts. The user should not be able to move the device or rotate the device once the lug ring has been properly place onto the lug nuts. The depth of the lug well 11, FIG. 2, can vary depending on the length of the wheel stud and lug nut. Standard wheel lugs and lug nuts common to trucks and other commercial vehicles will provide the dimension and shape for the lug ring's lug wells. This does not limit the scope of the invention and it should be understood that the concept for the lug ring is meant to cover any wheel that has one or more exposed wheel stud and lug nut.

The exterior surface 15 of the lug ring can be made from a number of materials and many finishes can be used depending upon the appearance the user would like to obtain. In the preferred embodiment, the convex exterior of the lug ring will be rounded or curved. Other shapes or dimension can be used depending on the desired appearance of the wheel and tire by the user. The rounded or curved exterior offers a sleek aero-dynamic look that can be easily cleaned. The curved exterior will have a seam along the interior inner and outer diameter edges of lug nut and the wheel rim wall and present few nooks and crannies that require detailed cleaning. The smooth surface of the rounded lug ring is easily cleaned with a wide range of cleaning solutions or just plain soap and water. The lack of angular surfaces that are exposed on a typical decorative lug nut reduces the amount of time a vehicle owner or operator will need to clean the wheel area.

In other embodiments of this device, the lug ring interior is made from alloys and materials other than PC. Softer alloys, such as tin or aluminum, can be stamped out to reproduce the same shape and dimensions as the lug ring described above. Instead of using a compression fit to attach the lug nut to the lug well, the lug nut would have clips or magnets attached within the lug wells to secure the lug nut to the lug ring. Various means such as clips and magnets for attaching hub caps are known to those skilled in the art and the limited description provided for the alternative embodiment does not in any way limit the scope of the claims and is to be read in the most broadly accepted interpretation of the claims made in this application.

Another feature with this device is the various color schemes that can be deployed on the exterior of the lug ring and the effect that various colors has on the wheel and rim of highly polished chrome. Another embodiment of the device is the ability to apply paint to the lug ring in order to match the vehicle color. By using color on the exterior of the lug ring within a highly finished metallic rim, the color is reflected within the wheel and the tire and rims take on the color of the lug ring exterior. The effect is dramatic and is visually pleasing to those observing the lug ring on a vehicle.

I claim:

1. A lug nut covering device for a wheel with studs and lug nut comprising a circular ring with a convex exterior side, a concave interior side, one or more lug wells placed within a well formed on the concave interior side wherein the one or more lug wells align with one or more lug nuts on a wheel.

2. The lug nut covering device of claim 1 further comprising; reinforcement webbing attached to an inner wall of the concave interior side of the lug ring and the one or more lug wells wherein the reinforcement webbing provides stability and support for the lug wells.

3. The lug nut covering device of claim 1 wherein the one or more lug wells are dimensioned to compress upon one or more lug nuts when the lug nut covering device is pressed onto the one or more lug nuts of the wheel.

4. The lug nut covering device of claim 1 further comprising an interior inner and outer diameter edge on the concave side of the lug nut covering device wherein the lug well projects from the concave side no farther than the inner and outer edges.

5. The lug nut covering device of claim 2 wherein the walls of the lug wells and the reinforcement webbing are manufactured using a high impact plastic with high tensile property.

6. The lug nut of claim 5 wherein the high impact plastic is a polycarbonate.

7. The lug nut of claim 5 wherein the walls of the lug wells and the reinforcement webbing are manufactured using Acrylonitrile butadiene styrene, or ABS.

9. The lug nut covering device of claim 1 wherein the convex exterior side is made with a chrome finish.

10. The lug nut covering device of claim 1 wherein the convex exterior side is made from a metal alloy.

11. The lug nut covering device of claim 1 wherein the convex exterior side is made from a plastic or petroleum based material.

12. The lug nut covering device of claim 2 wherein the material for the reinforcement webbing and walls of the lug well are made from a soft metal.

13. The lug nut covering device of claim 2 wherein one or more lug wells attaches to one or more lug nuts by means of clips or magnets.

14. A method for covering and protecting lug nuts and wheel studs on a wheel comprising pressing a circular ring with a convex exterior side, a concave interior side, reinforcement webbing attached to an inner wall of the concave interior side, one or more lug wells strategically placed within the reinforcement webbing wherein the one or more lug wells fit over and onto one or more lug nuts and wheel studs of the wheel.

15. The method for covering and protecting lug nuts and wheel studs of claim 14 wherein the concave interior side has an interior inner diameter and interior outer diameter edges, the wheel has an inner surface wall and when the circular ring is pressed onto one or more lug nuts the edges form a near seamless joint with the inner surface wall of the wheel.
